(19) United States
(12) Patent Application Publication
(10) Pub. No.: US 2004/0134433 A1
(43) Pub. Date: Jul. 15, 2004

(54) Animal bed

(76) Inventor: Chris Z. Holder, Sisters, OR (US)

Correspondence Address: Carl D. Crowell, P.O. Box 923, Salem, OR, 97308, US

(21) Appl. No.: 10/751,828

(22) Filed: Jan. 5, 2004

Related U.S. Application Data
(60) Provisional application No. 60/439,079, filed on Jan. 8, 2003.

(51) Int. Cl. A01K 29/00

(52) U.S. Cl. 119/28.5

(57) ABSTRACT

An animal bed for dogs or other pets including a bed top and a bed bottom side, the bed top having a perimeter with a series of bed bolster rails, which are generally a semi-rigid foam within a fabric sleeve. The bed bottom side has a bottom access preferably in the form of a fold over closure. The bed is filled with a bed filler of either loose material or a pad. Disposed on the bed top are a series of corner clips to which a removable pad, bed sides, or a dome cover may be attached.

### CROSS-REFERENCE TO RELATED APPLICATION

Provisional Patent Application Filed Jan. 8, 2003, Application No. 60/439079

### FIELD OF THE INVENTION

This invention relates to an animal bed for dogs or other small animals and more particularly to an animal bed with characteristics for maintaining a cleaner pet area.

### BACKGROUND OF THE INVENTION

The flooring in most kennels is concrete, wood, vinyl or any other hard surface, which is often uncomfortable for animals. The lack of a soft resting place can aggravate arthritic conditions and other joint problems, including hip dysplasia. The lack of a soft resting place can also cause calluses and wear the hair off of elbows, which is a particular problem for show dogs and their owners.

One solution to this problem is to fill the animal bed with filler providing cushioning for the pet thereby eliminating the discomfort and potential calluses and physical wear on the pet. Commonly, these are the pillow type beds that are filled with a variety of material. For example, cedar shavings are a natural filling that has the added benefit of repelling parasites such as fleas that may be living on the pet. However, some pets are allergic to such fillers requiring the purchase of a different bed. Another common filling is a polyester filling that is initially soft and comfortable but quickly goes either flat or lumpy leaving the pet in an uncomfortable bed. Most of these beds are inexpensive, and as a result they typically are made from low-grade exterior fabrics. Holes tend to wear quickly in this fabric and eventually the filling falls out the holes, or the bed becomes so soiled that it requires disposal and replacement.

Higher quality filled beds are not only of a higher quality fabric but often have a zipper or other closure means that allows the filling be changed and the cover to be washed. Unfortunately, this process can be very challenging as the filling can be extremely messy as well as the filling has potential to foul and eventually ruin the expensive zippers or other closure means. Again, the pet owner has the expense of purchasing a new animal bed. Additionally, the dirt and dander from the pet that is deposited on these pillow-type animal beds has no way of being contained within the bed and thereby creates a mess around the area where the animal and his bed lies.

If towels, carpets, blankets or similar material is used for bedding for pets either in the home or in a kennel, they must be laundered frequently. In the case of boarding kennels, pet bedding must be laundered daily to avoid the spreading of fleas or illnesses among pet borders. In a kennel with a large number of enclosures, commercial grade washing and drying equipment is often required as these bedding solutions can be both numerous and quite bulky.

It is, therefore, an object of the present invention to provide a soft, durable resting place on a bed-type apparatus for a pet wherein the general structure and fabric upon which the dog or other animal rests is easily and inexpensively cleaned, keeps the area surrounding the animal bed clean, and the bed is highly versatile in its application. Another object of the invention is to provide an animal bed that may be easily and selectively filled with a variety of material at the user level whether it is for pet comfort, parasite control, or a seasonal preference.

Yet another object of the invention is to provide a bed that may be easily and securely filled to avoid the leakage of filling and to permit the filling or emptying of the bed without cross contamination of the outside of the bed or the closure means which may become soiled and fouled.

Additional objects and advantages of the invention will be set forth in part in the description which follows, and in part will be obvious from the description, or may be learned by practice of the invention.

### SUMMARY OF THE INVENTION

To achieve these and other objects, the present invention provides an animal bed comprising: a bed, a perimeter of semi-rigid rails or bolster rails, corner connection rings, a dome with connection clips and a pad with connection clips. The bed is comprised of a top side and a bottom side and is designed to contain a filler or foam insert. On the bottom side of the bed is a bottom access. The bottom access facilitates the removal of the bed filler for cleaning of the bed or replacement of the bed filler.

It is to be understood that both the foregoing general description and the following detailed description are exemplary and explanatory but are not restrictive of the invention.

### BRIEF DESCRIPTION OF THE DRAWINGS

The accompanying drawings, which are incorporated in and constitute a part of this specification, illustrate a preferred embodiment as well as alternate embodiments of the invention and, together with the description, serve to explain the principles of the invention.

FIG. 1 is a perspective view of the preferred embodiment of the present invention.

FIG. 2 is a cross-section taken along 2-2 of FIG. 1 detailing elements of the preferred embodiment of the present invention.

FIG. 3 is a fragmentary perspective view of a corner of the preferred embodiment of the present invention partially disassembled.

FIG. 4 is a perspective bottom view of the preferred embodiment of the present invention.

FIG. 5 is a perspective view of an alternate embodiment of the present invention.

FIG. 6 is a perspective view of another alternate embodiment of the present invention.

### DETAILED DESCRIPTION OF THE PREFERRED EMBODIMENT

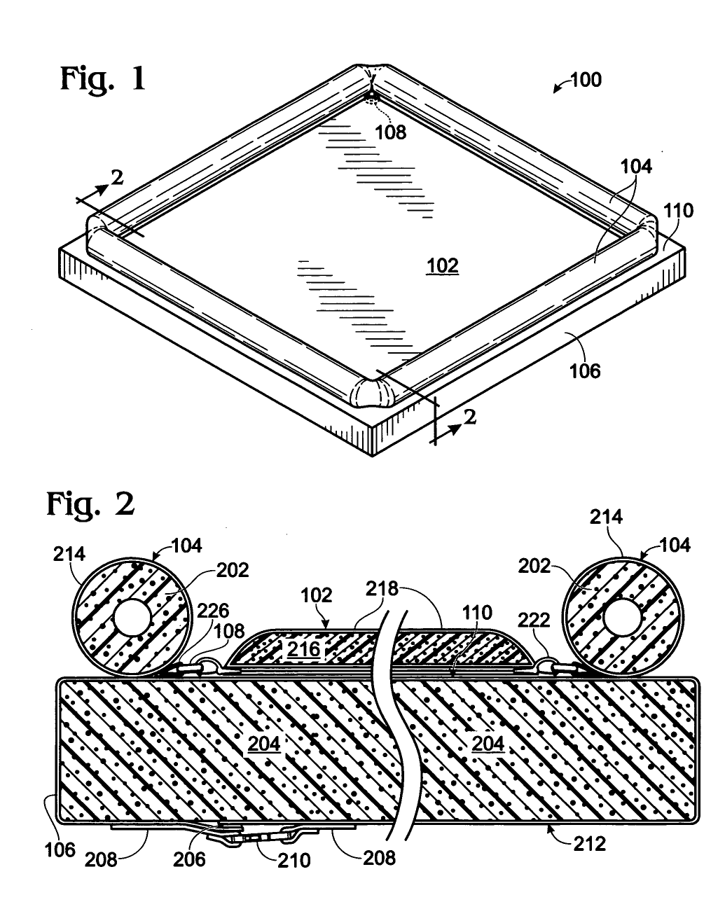

FIG. 1 is a perspective view of the preferred embodiment of the present invention. Animal Bed 100 is primarily constructed from a strong fabric such as DuPont CORDURA® nylon or a similar type fabric. Assembly of Animal Bed 100 is preferably by a standard means such as stitching, although glues and tapes may be used. Animal Bed 100 has a Bed Base 106 that is preferably a square or rectangular shape, but may be round. In the preferred rectangular embodiment, a series of Bolster Rails 104 define the perimeter of Pet Bed 100. Each Bolster Rail 104 is approximately the length of a side of Animal Bed 100 and is attached to Bed Top 110 of Bed Base 106 along a single line that is preferably along the perimeter of Bed Top 100, spaced in from the edge approximately the length of the radius of a Bolster Rail 104. Bolster Rails 104 are attached to Bed Top 110 by stitching, gluing or other attachment means. Each Bolster Rail 104 is a hollow sleeve that contains a rail insert (not shown). With the rail inserts in place, the outer edge of Bolster Rail 104 defines a perimeter that approximately matches the perimeter of Bed Base 106.

For added comfort for the pet, Bed Pad 102 is placed on Bed Top 110 interior to the perimeter of Bolster Rails 104. Each corner of Bed Pad 102 is anchored to Bed Top 110 using attachment clips (not shown) clipped to Corner Connection Rings 108 that are affixed in each corner of Animal Bed 100. Bed Pad 102 is a pillow with light filling where the cover, in the preferred embodiment is a washable fleece. Alternatively, the Bed Pad 110 can be of a variety of coverings and fillings depending upon the pet and pet owner's preferences. Some pets may prefer that Bed Pad 103 is simply a blanket or fleece with no filling at all as Bed Base 106 provides adequate padding.

In an alternate embodiment, Animal Bed 100 is round and there is a single Bolster Rail 104 around the circumference of Animal Bed 100. A plurality of rings are placed around the perimeter of the interior of Rail 104 along the juncture of Bolster Rail 104 and Bed Top 110 for the attachment of Bed Pad 102 or other attachments such as bed sides or bed cover.

FIG. 2 is a cross-section taken along 2-2 of FIG. 1 detailing elements of the preferred embodiment of the present invention. Bolster Rail 104 comprises a Rail Pocket 214 encasing a Rail Insert 202. Each Rail Pocket 214 is attached to Bed Top 110 along a single line, such as by stitching. The line is preferably along the perimeter of Bed Top 110, spaced in from the edge of Bed Top 100 approximately the length of the radius of Bolster Rail 104, such that with Rail Insert 202 in place, the outer edge of Bolster Rail 104 defines a perimeter that essentially matches the perimeter of Animal Bed 100. On at least one end of each Rail Pocket 214 is a reclosable opening (not shown). The Rail Pockets removably receive Rail Inserts 202 which are preferably of a semi-rigid foam material. In the rectangular Animal Bed 100 form, the corner opening may be of simple Velcro™ in two opposing corners, each opening providing access to the two adjoining Bolster Rails 104.

In each corner of Animal Bed 100 and at the interior junction of Bolster Rails 104 attached to Bed Top 110 is a Corner Ring Attach Strap 226. Attached to the Corner Ring Attach Strap 226 is Corner Connection Ring 108 for the attachment of Bed Pad 102 in the preferred embodiment. In an alternate embodiment, Corner Ring Attach Strap 226 and Corner Connection 108 can be replaced by a single loop of webbing. Bed Pad 102 is comprised of a Pad Cover 218 that is filled with Pad Filling 216. Pad filling 216 is a polyester filling in the preferred embodiment, but may also be pad only, therefore having no filling. However, Bed Pad 102 may be of a softer less durable material than the bed. Suitable materials for Bed Pad 102 include synthetic or natural fleeces, faux furs, or other soft and or thermally insulating materials. Bed Pad 102 has Pad Attach Straps 220 that are attached to the bottom of Bed Pad 102 and each strap has a Pad Attach Clip 222 attached to each end of Pad Attach Strap 220 and Bed Pad 102 is securely attached in each corner to Corner Connection Rings 108. Bed Pad 102 is preferably designed to be easily machine washed.

Bed Base 106 has a Bed Filler 204 for cushioning comfort for the pet or animal. In the preferred embodiment, Bed Base 106 is filled through the fold over closure shown in FIG. 2 and secured with Bed Closure Straps 208. At the ends of each Bed Closure Strap 208 is a Bed Closure Clip 210. For additional security, in the preferred embodiment Bed Closure Velcro™ 206 is attached along the width of the fold over closure eliminating the escape of loose Bed Filler 204. Bed Filler 204 may include any cushioning material such as open cell foam, wood shavings or even loose batting.

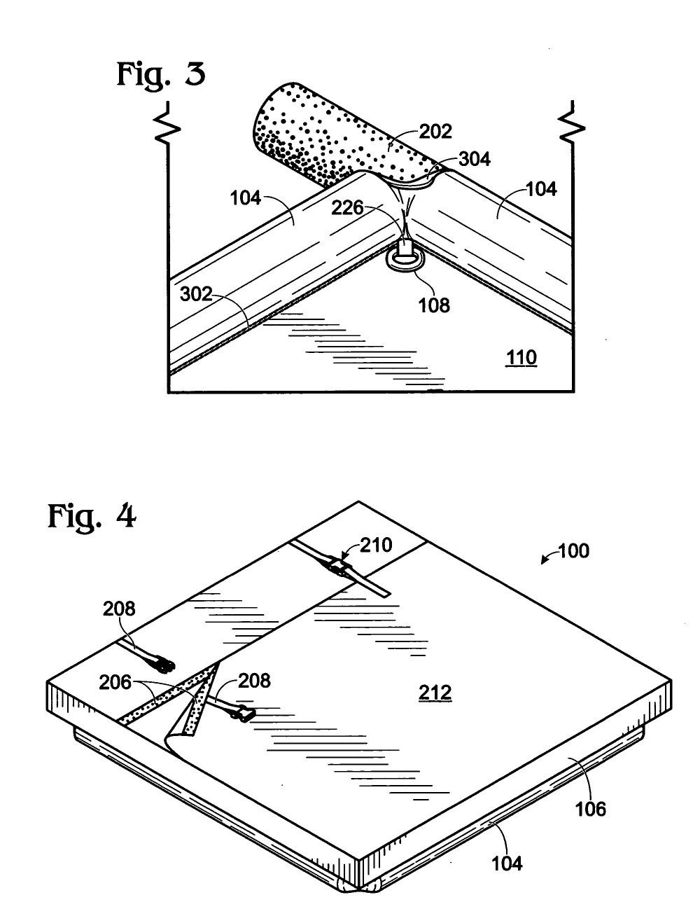

FIG. 3 is a fragmentary perspective view of a corner of the preferred embodiment of the present invention partially disassembled. In this preferred embodiment, Corner Opening 304 utilizes Velcro™ to permit the access of two Rail Pockets 214 for insertion of Rail Inserts 202 at a single corner. In FIG. 3, Bolster Rail 104 has been rolled back. Visible is Rail Crease 302 located at the juncture of the Bolster Rail 104 and Bed Top 110. This Bolster Rail 104 structure provides the added benefit of defining the inner bed with a Rail Crease 302. Rail Crease 302 is the point where Bolster Rail 104 and Bed Top 110 attach such that fabric from both elements is in contact with one another. This Rail Crease 302 acts as a trap to collect dirt and debris from exiting Animal Bed 100. Dirt and debris in the Rail Crease 302 is also not easily dislodged in casual use keeping the dirt and debris from getting back onto the pet. In cleaning the Animal Bed 100, Rail Crease 302 can be easily accessed by rolling the Bolster Rail 104 back. Rail Crease 302 may then be easily vacuumed or wiped clean.

Also shown is a Corner Connection Ring 108 held in place by Corner Ring Attach Strap 226. In the preferred embodiment, Bed Pad 102 is attached with Bed Attach Clips 222 to Corner Connection Rings 108. In alternate embodiments, other elements can be attached to Corner Connection Rings 108 such as side walls or a cover. With the connection means in the corners of Pet Bed 100, the pet experiences no discomfort due to the connection hardware, yet the bed is securely fastened eliminating slipping or bunching.

FIG. 4 is a perspective bottom view of the preferred embodiment of the present invention. The bottom access may be any simple closure but is preferably a fold over closure such as is commonly found on “dry-bags” with a pair of Bed Closure Straps 208 held by Bed Closure Clips 210. Additionally, Bed Closure Velcro™ 206 spans the width of Bed Bottom 212 just slightly inside of the edge of the bottom access so as not to be fouled by dirt and debris from the floor on which the Animal Bed 100 lies, yet close enough to the edge of the opening so as not to be fouled by Bed Filler 204.

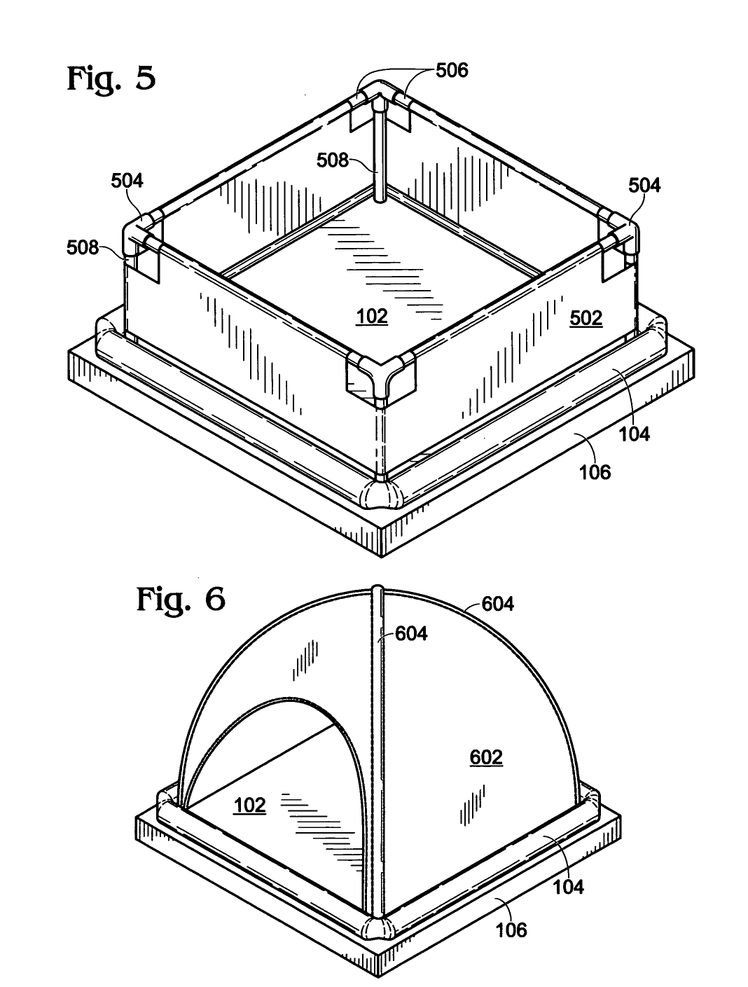

FIG. 5 is a perspective view of an alternate embodiment of the present invention. In FIG. 5, Animal Bed 100 is shown with Bed Sides 502 placed just inside Bolster Rails 104. Bed Sides 502 is supported by Bed Side Reinforcement Rails 506 and Bed Side Vertical Reinforcement Rails 508 which are connected at each corner of Pet Bed 100 by Bed Side Corner Connector 504. At the base of each Bed Side Vertical Reinforcement Rail 508 there is a connection means (not shown) that attaches to Corner Connection Ring 108 in order to hold Bed Sides 502 essentially perpendicular to Bed Top 110. Bed Sides 502 are constructed from a strong fabric such as DuPont CORDURA® nylon or a similar type fabric.

FIG. 6 is a perspective view of another alternate embodiment of the present invention. Often pets prefer a covering over them while sleeping or resting in their beds. FIG. 6 depicts an Animal Bed Domed Cover 602 that is supported by Cover Support Ribs 604. Animal Bed Domed Cover 602 has an opening on one side for the pet to enter and exit Animal Bed 100. Animal Bed Dome Cover 602 is attached at each corner by security clips (not shown) that attach to Corner Connection Ring 108 along with Bed Pad 102. Animal Bed Domed Cover 602 may be a thin material, or thicker thermal material than Animal Bed 100, if desired. Preferably Animal Bed Domed Cover 602 is of a collapsible fabric that may include rigid or semi-rigid Cover Support Ribs 604 to keep the dome upright.

Wherein the terms and expression which have been employed in the foregoing specification are used therein as terms of description and not of limitation, there is no intention, in the use of such terms and expression, of excluding equivalents of the features shown and described or portions thereof, it being recognized that the scope of the invention is defined and limited only by the claims which follow.

I claim:

1. An animal bed having a bed base, said bed base having a bed bottom and a bed top, said bed top having a perimeter defining a shape of said bed base, and a bed filler disposed between said bed bottom and said bed top, comprising:
at least one cylindrical bolster rail comprised of a rail pocket having at least one corner opening, and at least one rail insert removably inserted through said corner opening of said rail pocket thereby forming said bolster rail;
wherein each of said bolster rails is substantially the length of a side of said bed top whereby each of said bolster rails is fixedly attached to each of the sides of said bed top along a line interior to said perimeter of said bed top creating a substantially enclosed border with said bolster rail around said perimeter of said bed top, whereby a rail crease is formed at an interior juncture of each said bolster rail and said bed top whereby dirt and debris from an occupant of said animal bed is contained along said rail crease.

2. The animal bed of claim 1, wherein the shape of said bed base is rectangular shaped.

3. The animal bed of claim 1, wherein the shape of said bed base is round wherein said bolster rail is formed by one said rail pocket having one said corner opening and one said rail insert removably inserted in said rail pocket through said corner opening, said bolster rail thereby is in the shape of a circle.

4. The animal bed of claim 2, further comprising:
a bed pad, said bed pad approximately the shape of the substantially enclosed border formed by said bolster rails and having at least one pad attach clip fixedly attached to said bed pad, and;
at least one corner attachment means attached to said bed top interior to the substantially enclosed border formed by said bolster rails whereby said pad attach clips are attached to said corner attachment means securing said bed pad to said bed top.

5. The animal bed of claim 2, further comprising an opening on said bed bottom whereby said bed filler can be removed, said opening spans a width of said bed bottom, said opening has a top flap of fabric overlapping a bottom flap of fabric, said opening is securely closed by a Velcro™ strip disposed between said top flap and said bottom flap spanning the width of said bed bottom thereby fixably attaching said top flap to said bottom flap.

6. The animal bed of claim 5, further comprising at least one pair of bed closure straps having a first end having a first end connecting means disposed thereon, and a second end having a second end connecting means disposed thereon, wherein said first end is fixedly attached to said top flap of fabric and said second end is fixedly attached to said bottom flap of fabric such that after closure of said Velcro™ strip said first end connecting means connects to said second end connecting means further securing the closure of said bed bottom.

7. The animal bed of claim 1, further comprising a bed side wall wherein said bed side wall is placed perpendicular to said bed top while with the substantially enclosed border formed by said bolster rails and extending above said bolster rails, said bed side wall forming a continuous wall along the interior of said bolster rails.

8. The animal bed of claim 1, further comprising a bed cover, said bed cover comprising:
a domed cover piece;
at least one flexible cover support rib;
at least one security clip; and
at least one cover opening;
wherein said domed cover piece is maintained in a domed shape by said flexible cover support ribs bent in the shape of a dome and spanning under said domed cover piece from corner to corner, said opening is of a size large enough to allow a pet or animal to enter and exit said animal bed, and each said security clip is attached to each said corner connection ring of said bed top thereby securing said domed cover to said animal bed.

9. A method for cleaning an animal bed, said animal bed having a bed top, a bed bottom, and a bed filler disposed between said bed top and said bed bottom, bolster rails attached to said bed top and defining a perimeter of said animal bed, said bolster rails formed from a rail pocket having a rail insert removably inserted therein and creating a rail crease at the attachment point along each length of said animal bed to said bed top, said method comprising the steps of:
removing said rail insert from said rail pocket;
laying said rail pocket away from a center point of said bed top exposing said rail crease;
cleaning said rail crease to remove dirt and dander left by an occupying pet.

10. The method of claim 9, further comprising the steps of:
removing said bed filler; and
washing said animal bed in a clothes washing device.
